(19) United States
(12) Patent Application Publication
(10) Pub. No.: US 2025/0053073 A1
(43) Pub. Date: Feb. 13, 2025

(54) OPTICAL ENGINE MODULE AND PROJECTION DEVICE

(71) Applicant: Coretronic Corporation, Hsin-Chu (TW)

(72) Inventor: Te-Ying Tsai, Hsin-Chu (TW)

(73) Assignee: Coretronic Corporation, Hsin-Chu (TW)

(21) Appl. No.: 18/784,875

(22) Filed: Jul. 25, 2024

(30) Foreign Application Priority Data
Aug. 11, 2023 (CN) 202311009303.5

(51) Int. Cl. G03B 21/14; G02B 27/00; G03B 21/20

(52) U.S. Cl. CPC G03B 21/145; G02B 27/0006; G03B 21/2066

(57) ABSTRACT

An optical engine module includes a cover, a light valve module, and a thermal glue. The cover has at least one filling hole, and includes a cover part having an opening, and support parts and connection parts vertically connected to the cover part. The light valve module includes a base disposed on the support parts, and a light valve element having a light emitting surface and a peripheral surface connected thereto. The light emitting surface corresponds to the opening and is spaced apart from the cover part. The connection parts surround the peripheral surface. The filling hole communicates with a space between the peripheral surface and the cover. The thermal glue is disposed between the light valve module and the cover, and connects the base, the peripheral surface, the cover part, the connection parts, and the support parts. A projection device includes the optical engine module, which achieves favorable heat dissipation efficiency.

### CROSS-REFERENCE TO RELATED APPLICATION

This application claims the priority benefit of China application serial no. 202311009303.5, filed on Aug. 11, 2023. The entirety of the above-mentioned patent application is hereby incorporated by reference herein and made a part of this specification.

### BACKGROUND

### Technical Field

The disclosure relates to an optical device and in particular relates to an optical engine module and a projection device including the optical engine module.

### Description of Related Art

In a common projection device, a light valve is used to convert an illumination beam from a light source module into an image beam. Then, the image beam is transmitted to a projection lens and projected out of the projection device by the projection lens to form a projection image. However, as the brightness of the projection image of the projection device improves, the heat generated during operation of the light valve increases significantly, which results in an excessive temperature difference between the front side of the light valve and the rear side of the light valve and causes a decline in the quality of the projection image.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The disclosure provides an optical engine module which has favorable efficiency in heat dissipation.

The disclosure further provides a projection device which includes the optical engine module and is capable of improving the efficiency in heat dissipation of the light valve to reduce the temperature difference between the front side of the light valve and the rear side of the light valve and improve the projection quality and product competitiveness.

Other objectives and advantages of the disclosure may be understood from the technical features disclosed hereinafter.

In order to achieve one, part, or all of the objectives or other objectives, an embodiment of the disclosure provides an optical engine module which includes a cover, a light valve module, and a thermal glue. The cover has at least one filling hole, and includes a cover part, and a plurality of support parts and a plurality of connection parts vertically connected to the cover part. The cover part has an opening, and the connection parts connect the support parts that are separated from each other. The light valve module includes a base and a light valve element. The light valve element is disposed on the base. The base is disposed on the support parts. The light valve element has a light emitting surface and a peripheral surface connected to the light emitting surface. The light emitting surface corresponds to the opening and is spaced apart from the cover part. The connection parts surround the peripheral surface. The at least one filling hole communicates with a space between the peripheral surface of the light valve element and the cover. The thermal glue is disposed between the light valve module and the cover. The thermal glue connects the base, the peripheral surface, the cover part, the connection parts, and the support parts.

In order to achieve one, part, or all of the objectives or other objectives, an embodiment of the disclosure provides a projection device which includes a light source module, an optical engine module, and a projection lens. The light source module is configured to provide an illumination beam. The optical engine module includes a cover, a light valve module, and a thermal glue. The cover has at least one filling hole, and includes a cover part, and a plurality of support parts and a plurality of connection parts vertically connected to the cover par. The cover part has an opening, and the connection parts connect the support parts that are separated from each other. The light valve module includes a base and a light valve element. The light valve element is disposed on the base, and the base is disposed on the support parts. The light valve module is disposed on a transmission path of the illumination beam, and is configured to convert the illumination beam into an image beam. The light valve element has a light emitting surface and a peripheral surface connected to the light emitting surface. The light emitting surface corresponds to the opening and is spaced apart from the cover part. The connection parts surround the peripheral surface. The at least one filling hole communicates with a space between the peripheral surface of the light valve element and the cover. The thermal glue is disposed between the light valve module and the cover. The thermal glue connects the base, the peripheral surface, the cover part, the connection parts, and the support parts. The projection lens is disposed on a transmission path of the image beam, and is configured to project the image beam out of the projection device.

Based on the above, the embodiments of the disclosure have at least one of the following advantages or effects. According to the design of the optical engine module of the disclosure, the thermal glue is disposed between the light valve, the base, and the cover. The thermal glue covers the base, the peripheral surface of the light valve, and multiple connection parts and multiple support parts of the cover without a gap, and in the direction perpendicular to the light emitting surface, the base and the peripheral surface of the light valve are connected to the cover without a gap through the thermal glue. Thereby, the heat dissipation area at the front side of the light valve is increased to improve the efficiency of the light valve in heat dissipation. In addition, since the heat at the front side of the light valve is quickly dissipated, the temperature difference between the front side of the light valve and the rear side of the light valve is reduced, which improves the projection quality of the projection device using the optical engine module.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a projection device according to an embodiment of the disclosure.

FIG. 2A is a partial perspective view of an optical engine module of the projection device of FIG. 1.

FIG. 2B is a perspective view of FIG. 2A from another perspective.

FIG. 2C is a cross-sectional view along the line I-I′ of FIG. 2A.

FIG. 3 is a cross-sectional view of an optical engine module according to another embodiment of the disclosure.

FIG. 4 is a cross-sectional view of an optical engine module according to another embodiment of the disclosure.

FIG. 5 is a cross-sectional view of an optical engine module according to another embodiment of the disclosure.

FIG. 6 is a cross-sectional view of an optical engine module according to another embodiment of the disclosure.

FIG. 7 is a perspective view of an optical engine module according to another embodiment of the disclosure.

FIG. 8 is a cross-sectional view of an optical engine module according to another embodiment of the disclosure.

FIG. 9 is a cross-sectional view of an optical engine module according to another embodiment of the disclosure.

FIG. 10A is a partial perspective view of an optical engine module according to another embodiment of the disclosure.

FIG. 10B is a cross-sectional view along the line II-II′ of FIG. 10A.

### DETAILED DESCRIPTION OF DISCLOSED EMBODIMENTS

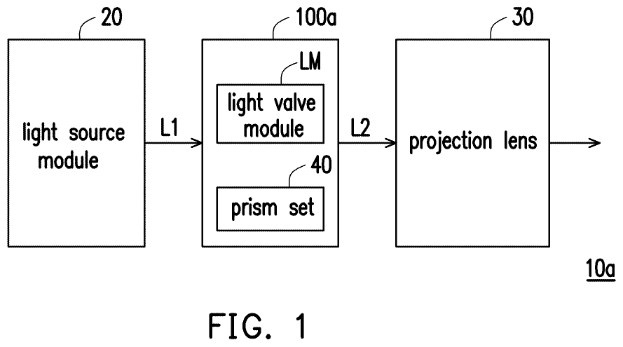

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.
FIG. 1 is a schematic diagram of a projection device according to an embodiment of the disclosure. First, referring to FIG. 1, in this embodiment, the projection device 10a includes a light source module 20, an optical engine module 100a, and a projection lens 30. The light source module 20 is configured to provide an illumination beam L1. The light source module 20 may include at least one light emitting element, a wavelength conversion element, a light uniformizing element, a filter element, and at least one light guide element, so as to provide beams of different wavelengths as the source of the illumination beam L1. The at least one light emitting element may be at least one light emitting diode (LED) or at least one laser diode (LD), but the disclosure is not intended to limit the light source module 20 to a certain type or form. The detailed structure and how to implement the light source module 20 have been sufficiently taught, suggested, and described in the common knowledge in the field, and thus will not be repeated here.

The optical engine module 100a includes a light valve module LM. The light valve module LM is disposed on the transmission path of the illumination beam L1 and configured to convert the illumination beam L1 into an image beam L2. For example, a light valve element of the light valve module LM may be a reflective optical modulator such as a liquid crystal on silicon panel or a digital micro-mirror device. Besides, the light valve element of the light valve module

LM may be a transmissive optical modulator such as a transparent liquid crystal panel, an electro-optical modulator, a magneto-optic modulator, or an acousto-optic modulator. The disclosure is not intended to limit the light valve element of the light valve module LM to a certain type or form. The detailed steps and how the light valve module LM converts the illumination beam L1 into the image beam L2 have been sufficiently taught, suggested, and described in the common knowledge in the field, and thus will not be repeated here.

The projection lens 30 is disposed on the transmission path of the image beam L2, and the projection lens 30 is configured to project the image beam L2 out of the projection device 10a and onto a projection target such as a screen or a wall. The projection lens 30 may include one optical lens or a combination of multiple optical lenses with diopters, such as various combinations of non-planar lenses including biconcave lenses, biconvex lenses, concave-convex lenses, convex-concave lenses, plano-convex lenses, and plano-concave lenses. In an embodiment, the projection lens 30 may further include a planar optical lens to guide the image beam L2 in a reflective manner. The disclosure is not intended to limit the projection lens 30 to a certain type or form.

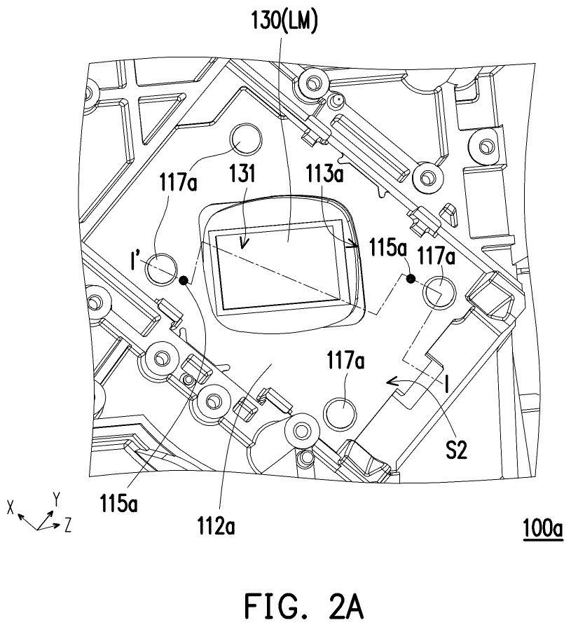

FIG. 2A is a partial perspective view of the optical engine module of the projection device of FIG. 1. FIG. 2B is a perspective view of FIG. 2A from another perspective. FIG. 2C is a cross-sectional view along the line I-I′ of FIG. 2A. For convenience, the prism set is omitted from FIG. 2A and FIG. 2B, the thermal glue and the light valve module are omitted from FIG. 2B, and only the structure of the cover is schematically shown.

Referring to FIG. 2A, FIG. 2B, and FIG. 2C, in this embodiment, the optical engine module 100a further includes a cover 110a and a thermal glue 140a. The cover 110a has at least one filling hole (two filling holes 115a are schematically shown), and includes a cover part 112a, and a plurality of support parts 114a and a plurality of connection parts 116a. The plurality of support parts 114a and the plurality of connection parts 116a are vertically connected to the cover part 112a. In this embodiment, the filling hole 115a is located in the cover part 112a. The cover part 112a has an opening 113a, and the connection parts 116a connect the support parts 114a separated from each other. The height of the support part 114a (the length in the direction perpendicular to the surface of the cover part 112a) is, for example, greater than the height of the connection part 116a. The light valve module LM includes a base 120 and a light valve element 130. For example, the light valve element 130 is disposed on the base 120, and the base 120 is disposed on (abuts against) the support parts 114a of the cover 110a. Here, the number of the support parts 114a is, for example, three, but the disclosure is not limited thereto.

In this embodiment, the light valve module LM has a front side and a rear side. The front side of the light valve module LM is a side adjacent to the opening 113a of the cover part 112a. More specifically, the front side is a side that receives the illumination beam LI and emits the image beam L2. In contrast, the rear side of the light valve module LM is defined as a side away from the opening 113a, such as the base 120. Here, the light valve element 130 is, for example, located between the base 120 and the cover part 112a. The support parts 114a and the connection parts 116a are disposed around a peripheral surface 135 of the light valve element 130. Specifically, the light valve element 130 has a light emitting surface 131 and the peripheral surface 135 connected to the light emitting surface 131. The peripheral surface 135 is, for example, located between the light emitting surface 131 and the base 120. The light emitting surface 131 corresponds to the opening 113a and is spaced apart from the cover part 112a. In an embodiment, the light emitting surface 131 includes, for example, an optical surface of the light valve element 130 for converting the illumination beam L1 into the image beam L2 and a surface surrounding the optical surface (the surrounding surface is, for example, parallel to the optical surface). That is to say, the light emitting surface 131 of the light valve element 130 is not in direct contact with the cover part 112a, and there is a gap between the light emitting surface 131 and the cover part 112a. Specifically, the light valve element 130 has, for example, the light emitting surface 131, a disposed surface 133 opposite to the light emitting surface 131, and the peripheral surface 135 connected to the light emitting surface 131 and the disposed surface 133. The disposed surface 133 is connected with the base 120. The connection parts 116a of the cover 110a surround the peripheral surface 135. The peripheral surface 135 of the light valve element 130 is embodied as a stepped surface. As shown in FIG. 2C, the shape of the peripheral surface 135 on a cross section perpendicular to the light emitting surface 131 has a plurality of line segments connected in a stepped shape.

In particular, referring to FIG. 2C, the filling hole 115a communicates with a space between the peripheral surface 135 of the light valve element 130 and the cover 110a, and the thermal glue 140a is disposed between the light valve module LM and the cover 110a. The thermal glue 140a is filled between the light valve module LM and the cover 110a via the filling hole 115a.

That is, the pressure and the plasticity of the glue material allow the filled thermal glue 140a to be filled in the space between the light valve module LM and the cover 110a, which means that the thermal glue 140a may connect the base 120, the peripheral surface 135 of the light valve element 130, the cover part 112a, the connection parts 116a, and the support parts 114a. Here, the thermal glue 140a is, for example, a light curable material or a thermally curable material, which means an uncured paste material or a curable material that is heated or irradiated with light of a special wavelength. The thermal conductivity of the thermal glue 140a is greater than or equal to 2 W/(m·K). The thermal glue 140a covers without a gap the peripheral surface 135 of the light valve element 130 and the side surfaces of the connection parts 116a and the support parts 114a of the cover 110a facing the peripheral surface 135 (for example, the ratio of the contact area between the thermal glue 140a and the peripheral surface 135 to the area of the peripheral surface 135 is greater than or equal to 95%). The cured thermal glue 140a is formed into an annular shape and surrounds the light valve element 130. For example, in a direction D perpendicular to the light emitting surface 131, the peripheral surface 135 of the light valve element 130 is connected to the cover 110a without an air gap through the thermal glue 140a, thereby improving the efficiency in heat dissipation. In an embodiment, a compressible material such as a porous foam material, rubber, or other materials may be disposed between the support parts 114a and the base 120. The compressible material may reduce or prevent the thermal glue 140a from leaking to the outer surface of the optical engine module 100a via the gap between the support parts 114a and the base 120.

In short, the disposed thermal glue 140a transfers the heat generated by the light valve element 130 to the cover 110a, which increases the area for heat dissipation at the front side of the light valve module LM and thereby improves the efficiency of the light valve module LM in heat dissipation. The heat generated by the light valve element 130 is transferred to the disposed thermal glue 140a through the peripheral surface 135 which directly contacts with the disposed thermal glue 140a. In addition, since the heat at the front side of the light valve module LM is quickly dissipated, the temperature difference between the front side of the light valve module LM and the rear side of the light valve module LM is reduced, which improves the projection quality of the projection device 10a using the optical engine module 100a.

Referring to FIG. 1 and FIG. 2C, in this embodiment, the optical engine module 100a of the projection device 10a may optionally include a prism set 40. The prism set 40 is disposed between the light valve module LM and the projection lens 30 on the transmission path of the illumination beam L1 and the transmission path of the image beam L2. The prism set 40 is, for example, a total internal reflection prism set which includes, for example, two prisms. After the illumination beam L1 enters the prism set 40, the illumination beam L1 is directed toward the light valve module LM due to total internal reflection. The image beam L2 from the light valve module LM passes through the prism set 40 and is then transmitted to the projection lens 30. However, the disclosure is not particularly intended to limit how the prism set is implemented. In addition, the optical engine module 100a further includes a dust-proof component 50. The dust-proof component 50 has, for example, an annular shape (may be circular or square, which is not particularly limited in the disclosure), and is made of an elastic material such as rubber. The cover 110a further includes a plurality of abutment protrusions 117a, and the cover part 112a has a first surface S1 and a second surface S2 opposite to each other. Moreover, the first surface S1 faces to the base 130, and the second surface S2 faces to the prism set 140. The filling hole 115a is, for example, a through hole penetrating the cover part 112a from the first surface S1 to the second surface S2. The support parts 114a are located on the first surface S1, and the abutment protrusions 117a are located on the second surface S2 and abut the prism set 40. Each of the abutment protrusions 117a is protruded from the second surface S2 toward the prism set 40. The number of abutment protrusions 117a may be greater than or equal to the number of support parts 114a. The dust-proof component 50 is located between the second surface S2 of the cover part 112a and the prism set 40 (that is, the dust-proof component 50 is in direct contact with the second surface S2 and the prism set 40), and configured to seal the cover 110a and the prism set 40, that is, to maintain the sealing property of the light emitting surface 131. Here, the cover part 112a, the support parts 114a, and the abutment protrusions 117a may be part of a casing of the optical engine module 100a. That is to say, the cover part 112a, the support parts 114a, and the abutment protrusions 117a are integrally formed with the casing of the optical engine module 100a, but the disclosure is not limited thereto.

During assembly, the base 120 of the light valve module LM is locked with the cover 110a (the light valve element 130 is disposed in an accommodation space between the cover 110a and the base 120), and then the gap between the light valve module LM and the cover 110a is filled with the thermal glue 140a via the filling hole 115a on the cover 110a, thereby solving the problem of insufficient contact area between the light valve module LM and the support parts 114a of the cover 110a without affecting the optical quality. Furthermore, since the thermal glue 140a is provided between the light valve module LM and the cover 110a, the requirement of dust-sealing the front side of the light valve module LM and the optical engine module is also fulfilled. In addition, since this embodiment uses the thermal glue 140a to fill the air gap between the light valve module LM and the cover 110a, the thermal resistance between the front side of the light valve module LM and the cover 110a is effectively reduced to improve the heat dissipation performance. That is to say, the thermal glue 140a may greatly increase the heat transfer path between the light valve module LM and the cover 110a, which means that the heat dissipation area and heat dissipation amount may be increased to improve the efficiency of the light valve module LM in heat dissipation.

Other embodiments will be described below as examples. It should be noted here that the following embodiments will be described with reference to the reference numerals and some of the contents of the foregoing embodiments, where the same reference numerals are used to represent the same or similar elements, and descriptions of the same technical contents will be omitted. Please refer to the foregoing embodiments for the omitted descriptions, which will not be repeated in the following embodiments.

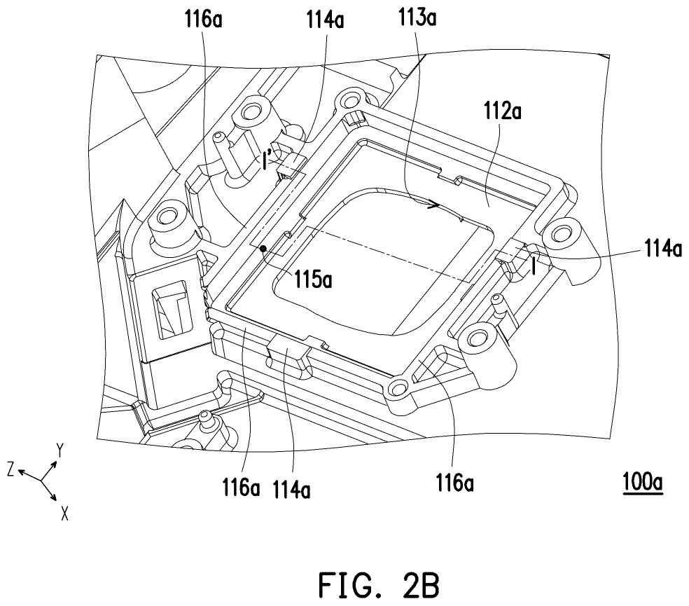

FIG. 3 is a cross-sectional view of an optical engine module according to another embodiment of the disclosure. Referring to FIG. 3, the optical engine module 100b of this embodiment is similar to the optical engine module 100a of FIG. 2C, and the main differences therebetween lie in that: in this embodiment, the cover 110b of the optical engine module 100b does not include the abutment protrusions 117a as shown in the optical engine module 100a of FIG. 2C, and the optical engine module 100b further includes a housing 150 and a housing dust-proof component 160. The housing 150 has an assembly port 151 and includes a plurality of housing abutment protrusions 153. The housing dust-proof component 160 has, for example, an annular shape (may be circular or square, which is not particularly limited in the disclosure), and is made of an elastic material such as rubber. The cover 110b is disposed on the housing 150, and an opening 113b of the cover part 112b is aligned with the assembly port 151. Here, the diameter of the opening 113b is smaller than the diameter of the assembly port 151. The filling hole 115b is located in the cover part 112b of the cover 110b, and the assembly port 151 exposes the filling hole 115b (that is, the projection range of the assembly port 151 on the cover part 112b covers the filling hole 115b and the opening 113b). The support parts 114b are vertically connected to the cover part 112b, and the extension direction of the housing abutment protrusions 153 is parallel to the extension direction of the support parts 114b. The housing abutment protrusions 153 abut the prism set 40, and the housing dust-proof component 160 is disposed between the housing 150 and the cover part 112b of the cover 110b for sealing. In addition, the projection device 10b of this embodiment further includes a prism dust-proof component 60 located between the housing 150 and the prism set 40 for sealing the housing 150 and the prism set 40. In an embodiment, the housing 150 may be part of the casing of the optical engine module 100b.

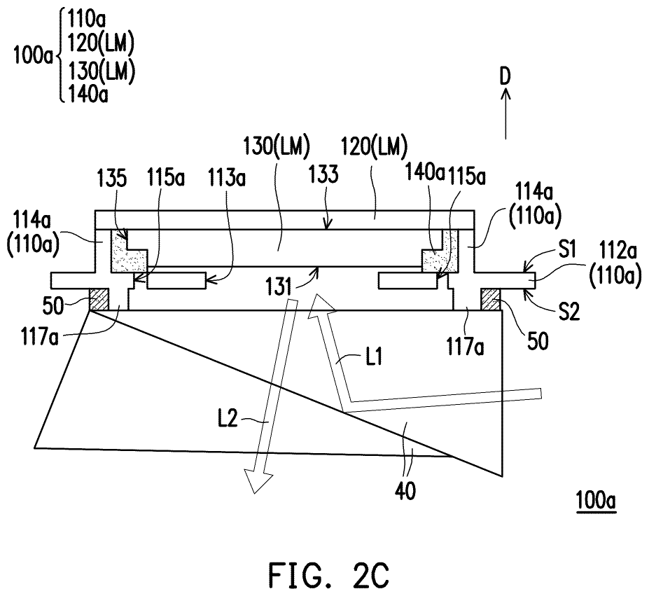

FIG. 4 is a cross-sectional view of an optical engine module according to another embodiment of the disclosure. Referring to FIG. 4, the optical engine module 100c of this embodiment is similar to the optical engine module 100a of the projection device 10a of FIG. 2C, and the main differences therebetween lie in that: regarding the range in which the dust-proof component 170 of the optical engine module 100c is disposed, in this embodiment, the dust-proof component 170 is disposed on the second surface S2 of the cover part 112a, and is located between the second surface S2 of the cover part 112a and the prism set 40 for sealing the cover 110a and the prism set 40. Here, the dust-proof component 170 also covers the filling hole 115a located in the cover part 112a. The filling hole 115a may be closed by the dust-proof component 170. Besides, since the prism set 40 is pressed against the dust-proof component 170, the thermal glue 140c is prevented from being dispersed in the optical machine cavity to affect the optical quality. For example, the dust-proof component 170 has an annular shape and has a plurality of through holes for a plurality of abutment protrusions 117a to pass through. The number of through holes is, for example, equal to the number of abutment protrusions 117a.

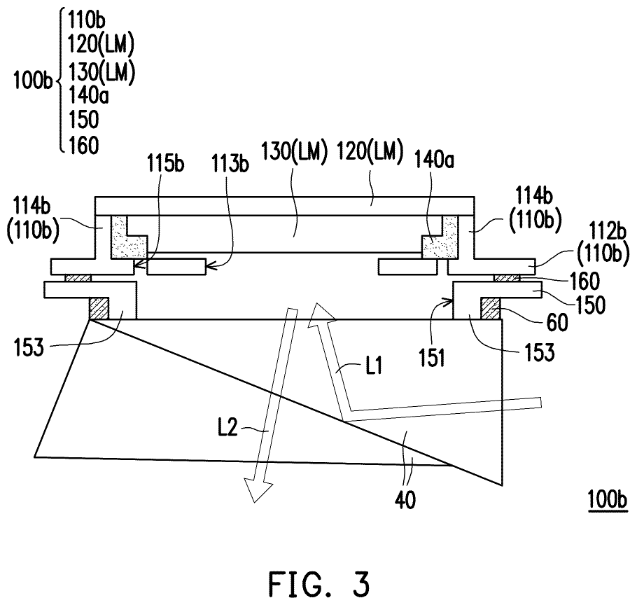

FIG. 5 is a cross-sectional view of an optical engine module according to another embodiment of the disclosure. Referring to FIG. 5, the optical engine module 100d of this embodiment is similar to the optical engine module 100b of FIG. 3, and the main differences therebetween lie in that: in this embodiment, the prism set may be omitted or be not shown. The cover part 112d of the cover 110d is vertically connected to the support parts 114d, each of the support parts 114d has a stepped surface ST1 on a side facing the thermal glue 140d, and the stepped surface ST1 and the peripheral surface 135 have complementary shapes at least partially. The thermal glue 140d is filled between the light valve module LM and the cover 110d via the filling hole 115d, and in the direction D perpendicular to the light emitting surface 131, the base 120 and the peripheral surface 135 of the light valve element 130 are connected to the cover 110d without a gap through the thermal glue 140d.

Since the support part 114d of this embodiment has the stepped surface ST1, the gap distance between the support part 114d of the cover 110d and the peripheral surface 135 may be reduced to reduce the usage of the thermal glue 140d. In addition, since the heat generated by the light valve module LM is transmitted through the thermal glue 140d, the heat transfer distance is shortened, which effectively reduces the thermal resistance and further helps the light valve module LM to dissipate heat.

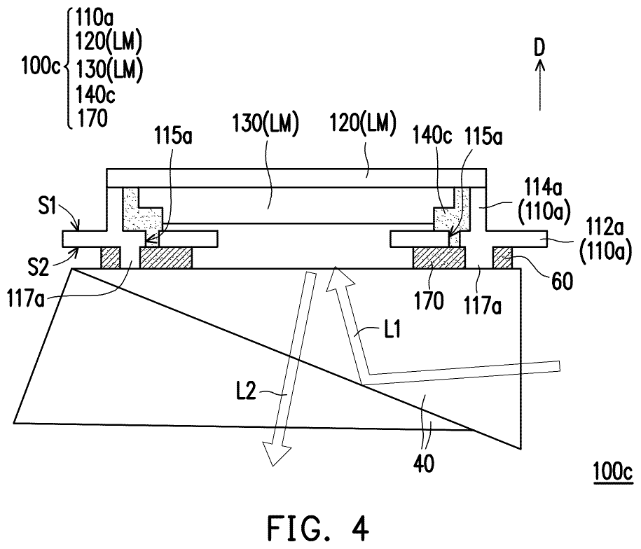

FIG. 6 is a cross-sectional view of an optical engine module according to another embodiment of the disclosure. Referring to FIG. 6, the optical engine module 100e of this embodiment is similar to the optical engine module 100b of FIG. 3, and the main differences therebetween lie in that: in this embodiment, the prism set may be omitted or be not shown. The optical engine module 100e further includes a heat transfer plate 180e disposed between the cover 110e (for example, the cover part 112e) and the base 120. The heat transfer plate 180e has a heat transfer plate opening 181 which is, for example, aligned with the light emitting surface 131. The heat transfer plate 180e includes a body part 182 and at least one extension part (one extension part 184e is schematically shown) vertically connected to the body part 182. The body part 182 is disposed on (in direct contact with) the cover part 112a, and the extension part 184e connects the base 120 and the body part 182. In this way, the thermal glue 140a directly connects the base 120, the peripheral surface 135 of the light valve element 130, and the heat transfer plate 180e (for example, the body part 182 and the extension part 184e). For example, in the direction D perpendicular to the light emitting surface 131, the base 120 and the peripheral surface 135 of the light valve element 130 are connected to the heat transfer plate 180e without a gap through the thermal glue 140a, which effectively improves the efficiency in heat dissipation. In particular, the extension part 184e provides a function of the support part 114e supporting the cover part 112e and the base 120. Therefore, in this embodiment, the extension part 184e may replace one support part 114b as shown in FIG. 3, but in other embodiments, the extension part 184e may be additionally provided without affecting the arrangement of the support parts 114b as shown in FIG. 3, which is still covered by the scope of protection of the disclosure. In another embodiment, the body part 182 of the heat transfer plate 180e may be connected to other heat dissipation components such as heat dissipation fins, and other heat dissipation devices in the projection system, such as fans, may dissipate heat from the heat dissipation fins so that the temperature of the light valve element 130 meets the required specifications.

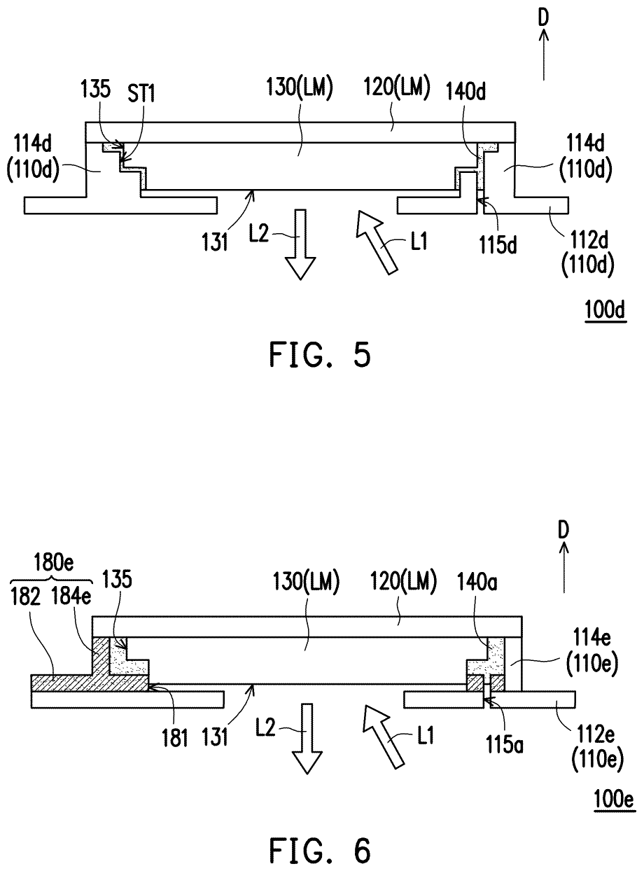

FIG. 7 is a cross-sectional view of an optical engine module according to another embodiment of the disclosure. Referring to FIG. 6 and FIG. 7, the optical engine module 100f of this embodiment is similar to the optical engine module 100e of FIG. 6, and the main differences therebetween lie in that: in this embodiment, the prism set may be omitted or be not shown. The heat transfer plate 180f has a plurality of extension parts 184f, and the side of the extension part 184f facing the thermal glue 140a has a stepped surface ST2, which effectively reduces the usage of the thermal glue 140a.

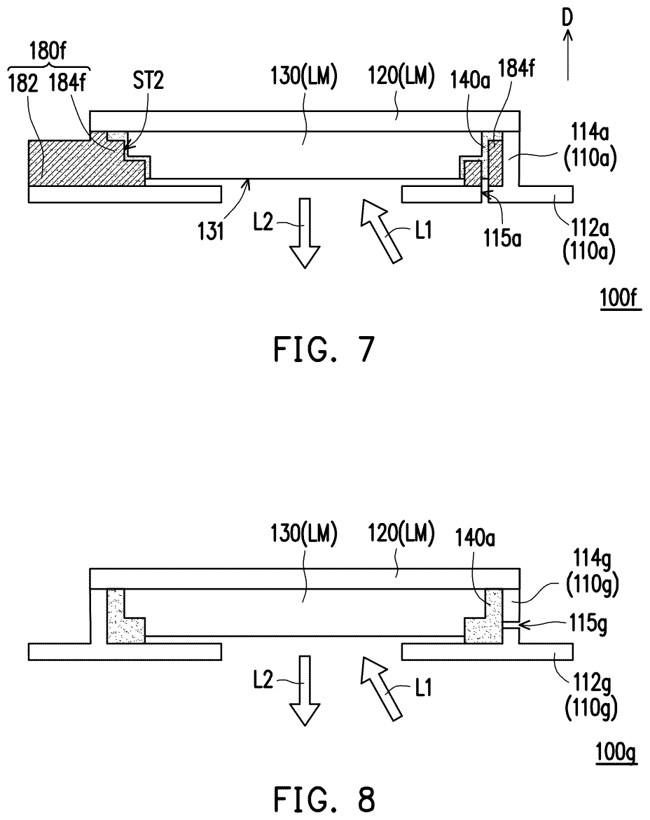

FIG. 8 is a perspective view of an optical engine module according to another embodiment of the disclosure. Referring to FIG. 8, the optical engine module 100g of this embodiment is similar to the optical engine module 100b of FIG. 3, and the main differences therebetween lie in that: in this embodiment, the prism set may be omitted or be not shown. The filling hole 115g is located in the support part 114g of the cover 110g that is vertically connected to the cover part 112g, which prevents the thermal glue 114g from volatilizing due to heat, dispersing in the optical machine cavity, adhering to the optical components (such as the prism set), and consequently reducing the brightness or quality if the filling hole 115g is not properly sealed. In other embodiments, the filling hole 115g may be located in the connection part.

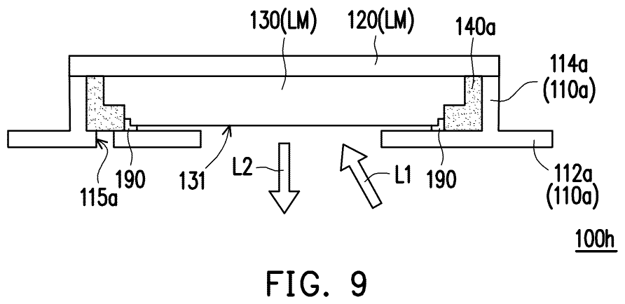

FIG. 9 is a cross-sectional view of an optical engine module according to another embodiment of the disclosure. Referring to FIG. 9, the optical engine module 100h of this embodiment is similar to the optical engine module 100b of FIG. 3, and the main differences therebetween lie in that: in this embodiment, the prism set may be omitted or be not shown. The optical engine module 100h further includes a compressible material 190, and at least part of the compressible material 190 is disposed between the light emitting surface 131 of the light valve element 130 and the periphery of the cover part 112a of the cover 110a and has an annular shape. The compressible material 190 is, for example, a porous foam material, rubber, or other materials with low thermal conductivity. The disposed compressible material 190 prevents the thermal glue 140a from dispersing to the light emitting surface 131 of the light valve element 130 and causing a decrease in imaging quality. From the perspective of the light emitting surface 131, the compressible material 190 may be a complete annular structure effectively blocking between the thermal glue 140a and the light emitting surface 131, which ensures that the thermal glue 140a does not overflow to the light emitting surface 131 in the 360-degree direction and affect the imaging. Here, in the cross-sectional view of FIG. 9, the thermal glue 140a may have an L shape, or in other embodiments, the thermal glue 140a may be shaped like a sheet and have a straight-line shape that is substantially parallel to the light emitting surface 131, but the disclosure is not limited thereto.

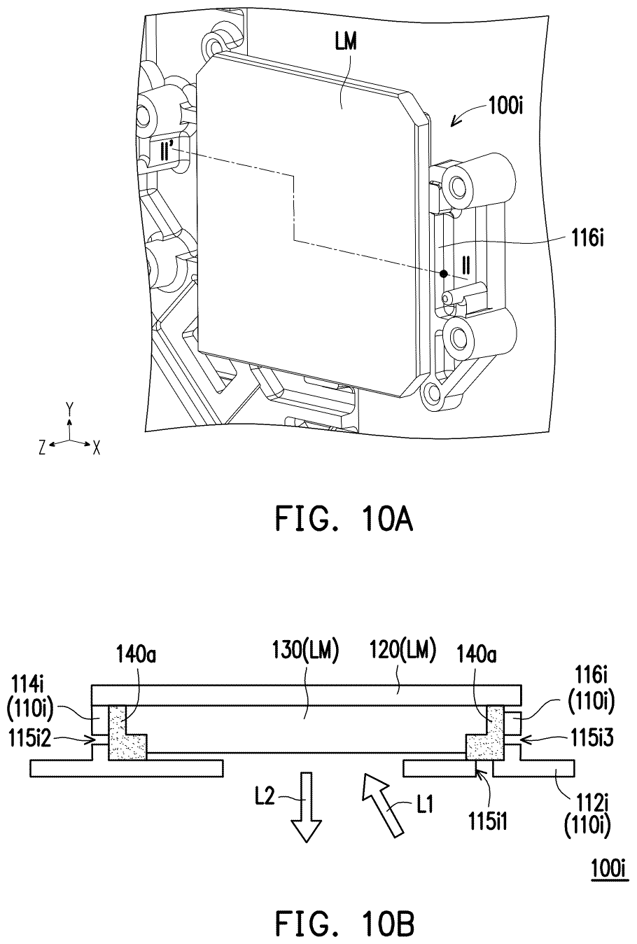

FIG. 10A is a partial perspective view of an optical engine module according to another embodiment of the disclosure. FIG. 10B is a cross-sectional view along the line II-II′ of FIG. 10A. Referring to FIG. 9, the optical engine module 100i of this embodiment is similar to the optical engine module 100b of FIG. 3, and the main differences therebetween lie in that: in this embodiment, the prism set may be omitted or be not shown. The filling hole 115i1 of the optical engine module 100i is located in the cover part 112i of the cover 110i, the filling hole 115i2 is located in the support part 114i of the cover 110i, and the filling hole 115i3 is located in the connection part 116i of the cover 110i.

To sum up, the embodiments of the disclosure have at least one of the following advantages or effects. According to the design of the optical engine module of the disclosure, the thermal glue is disposed between the light valve, the base, and the cover. The thermal glue covers the base, the peripheral surface of the light valve, and multiple connection parts and multiple support parts of the cover without a gap, and in the direction perpendicular to the light emitting surface, the base and the peripheral surface of the light valve are connected to the cover without a gap through the thermal glue. Thereby, the heat dissipation area at the front side of the light valve is increased to improve the efficiency of the light valve in heat dissipation. In addition, since the heat at the front side of the light valve is quickly dissipated, the temperature difference between the front side of the light valve and the rear side of the light valve is reduced, which improves the projection quality of the projection device using the optical engine module.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An optical engine module, comprising:
a cover, having at least one filling hole and comprising a cover part, a plurality of support parts, and a plurality of connection parts, wherein the support parts and the connection parts are vertically connected to the cover part, the cover part has an opening, and the connection parts connect the support parts that are separated from each other;
a light valve module, comprising a base and a light valve element disposed on the base, wherein the base is disposed on the support parts of the cover, the light valve element has a light emitting surface and a peripheral surface connected to the light emitting surface, the light emitting surface corresponds to the opening and is spaced apart from the cover part, the connection parts surround the peripheral surface, the at least one filling hole communicates with a space between the peripheral surface of the light valve element and the cover; and
a thermal glue, disposed between the light valve module and the cover, wherein the thermal glue connects the base, the peripheral surface, the cover part, the connection parts, and the support parts.

2. The optical engine module according to claim 1, wherein the at least one filling hole is located in at least one of the cover part, the connection parts, and the support parts.

3. The optical engine module according to claim 1, further comprising:
a housing, having an assembly port, wherein the cover is disposed on the housing, and the opening is aligned with the assembly port.

4. The optical engine module according to claim 3, further comprising:
a housing dust-proof component disposed between the housing and the cover part of the cover.

5. The optical engine module according to claim 1, wherein the cover further comprises a plurality of abutment protrusions, the cover part has a first surface and a second surface opposite to each other, the support parts are located on the first surface, and the abutment protrusions are located on the second surface.

6. The optical engine module according to claim 5, further comprising:
a dust-proof component, disposed on the second surface of the cover part, wherein the at least one filling hole is located in the cover part, and the dust-proof component covers the at least one filling hole.

7. The optical engine module according to claim 1, wherein the peripheral surface of the light valve element is a stepped surface.

8. The optical engine module according to claim 1, wherein the support parts of the cover each have a stepped surface on a side facing the thermal glue.

9. The optical engine module according to claim 1, further comprising:
a heat transfer plate, disposed between the cover and the base, wherein the heat transfer plate comprises a body part and at least one extension part vertically connected to the body part, the body part is disposed on the cover part, the at least one extension part is connected to the base, and the base and the peripheral surface of the light valve element are connected to the heat transfer plate without a gap through the thermal glue in a direction perpendicular to the light emitting surface.

10. The optical engine module according to claim 9, wherein a side of the at least one extension part, which faces the thermal glue, has a stepped surface.

11. The optical engine module according to claim 1, further comprising:
a compressible material, at least part of which is disposed between the light emitting surface of the light valve element and a periphery of the cover part of the cover and has an annular shape.

12. The optical engine module according to claim 1, wherein the thermal glue comprises a light curable material or a thermally curable material, and a thermal conductivity of the thermal glue is greater than or equal to 2 W/(m·K).

13. A projection device, comprising:
a light source module, configured to provide an illumination beam;
an optical engine module, comprising:
a cover, having at least one filling hole and comprising a cover part, a plurality of support parts, and a plurality of connection parts, wherein the support parts and the connection parts are vertically connected to the cover part, the cover part has an opening, and the connection parts connect the support parts that are separated from each other;
a light valve module, disposed on a transmission path of the illumination beam and configured to convert the illumination beam into an image beam, wherein the light valve module comprises a base and a light valve element, the light valve element is disposed on the base, the base is disposed on the support parts of the cover, the light valve element has a light emitting surface and a peripheral surface connected to the light emitting surface, the light emitting surface corresponds to the opening and is spaced apart from the cover part, the connection parts surround the peripheral surface, and the at least one filling hole communicates with a space between the peripheral surface of the light valve element and the cover; and
a thermal glue, disposed between the light valve module and the cover, wherein the thermal glue connects the base, the peripheral surface, the cover part, the connection parts, and the support parts; and
a projection lens, disposed on a transmission path of the image beam and configured to project the image beam out of the projection device.

14. The projection device according to claim 13, wherein the optical engine module further comprises a prism set, and the prism set is located on the transmission path of the image beam and disposed between the light valve module and the projection lens.

15. The projection device according to claim 14, wherein the optical engine module further comprises a dust-proof component, the cover further comprises a plurality of abutment protrusions, the cover part has a first surface and a second surface opposite to each other, the support parts are located on the first surface, the abutment protrusions are located on the second surface and abut the prism set, and the dust-proof component is located between the cover part and the prism set.

16. The projection device according to claim 14, wherein the optical engine module further comprises:
a housing, having an assembly port and comprising a plurality of housing abutment protrusions, wherein the opening is aligned with the assembly port, and the housing abutment protrusions abut the prism set; and
a housing dust-proof component, disposed between the housing and the cover part of the cover.

17. The projection device according to claim 16, wherein the optical engine module further comprises a prism dust-proof component, located between the housing and the prism set.
